(19) United States
(12) Patent Application Publication
(10) Pub. No.: US 2022/0177218 A1
(43) Pub. Date: Jun. 9, 2022

(54) DISPOSABLE BEVERAGE BAG AND BREWER ADAPTER

(71) Applicant: Alice Coffee, LLC, West Olive, Michigan, MI (US)

(72) Inventors: Dean G. Rotchin, Loxahatchee, FL (US); Peter C. Krupp, West Olive, MI (US); David W. Hansen, San Francisco, CA (US)

(73) Assignee: Alice Coffee, LLC, West Olive, Michigan, MI (US)

(21) Appl. No.: 17/434,648

(22) PCT Filed: Feb. 27, 2020
(86) PCT No.: PCT/US2020/020058

§ 371 Date: Aug. 27, 2021

Related U.S. Application Data
(63) Continuation of application No. 16/290,281, filed on Mar. 1, 2019.

(51) Int. Cl. B65D 85/804; B65D 65/46; B65D 30/00; A23F 5/26; B65D 77/04; A47J 31/40; A47J 31/36; B65D 33/28

(52) U.S. Cl. CPC B65D 85/8043; B65D 65/466; B65D 29/00; B65D 33/28; B65D 77/04; A47J 31/407; A47J 31/36; A23F 5/262

(57) ABSTRACT

A disposable beverage bag, filled with beverage material, for use in preparing a beverage in connection with single-serve beverage brewing machines. The beverage bag is preferably made from environmentally-friendly woven or knitted materials that are biodegradable, compostable and/or recyclable, or any other suitable stretchy, water-permeable, eco-friendly material. The beverage bag offers an easy, convenient, cost-effective and mess-free way to prepare beverages, and easy, eco-friendly disposal. The beverage bag can be configured to work with any beverage brewing machine, and it can be filled with any suitable beverage material, including coffee, tea, and hot chocolate. An adapter comprising a gasket and plug can be installed in the beverage machine to allow for the beverage bag to be used without the need for a reusable cup.

### BACKGROUND

There are numerous well-known machines available for making a single-serve brewed beverage. The present invention is intended for use with any of these systems, including the well-known beverage brewing systems sold by Keurig®, Nespresso® and others. These brewers are designed to quickly brew a single cup of coffee, tea or other beverage, and they have become increasingly popular with consumers, with an estimated 41% of all U.S. consumers owning one of these machines as of 2018. The brewers typically use self-contained, single-serve beverage pods. Some systems also can be configured to make multi-cup “carafe” sized brews.

The standard beverage configuration used with the Keurig® brewer is what Keurig® terms the K-Cup®. As shown in FIG. 1, a K-Cup® 1 is a self-contained, single-serve, disposable beverage cartridge which includes a plastic cup 2, a paper filter 4 positioned inside the plastic cup 2, beverage material 6 (such as ground coffee) inside the paper filter 4, and a foil lid 8 that seals the K-Cup® 1.

When a K-Cup® is placed in the Keurig® brewer's brewing chamber and the chamber is closed, the brewer's hollow upper inflow needle pierces the foil lid 8 and a hollow lower discharge needle pierces the bottom of the plastic cup 2 without piercing the paper filter 4. When the brew button is pressed, the brewer injects hot, pressurized water into the coffee grounds 6 (or other beverage material) contained in the paper filter 4. The K-Cup® acts as a pressurized chamber during the brewing process. The brewed coffee (or other beverage) percolates through the paper filter 4 (which captures beverage material sediment) and flows out of the hollow lower discharge needle into a coffee cup or other beverage container.

The Keurig® brewing system provides a convenient way to make a single, fresh serving of a beverage. The standard K-Cup® configuration provides for easy, mess-free preparation and cleanup—there is no pre-brew grinding, measuring or spillage by the end user; the K-Cup® fits easily into the brewing chamber; and, after brewing is complete, the spent K-Cup® can be removed and thrown away, again without making a mess.

However, there are significant shortcomings with the K-Cup® brewing technique, not the least of which is that K-Cup® type cartridges are relatively expensive. Also, they are made largely of non-recyclable plastic, which creates significant environmental issues since they are not biodegradable, compostable or recyclable. The capsules used with Nespresso® and other brewers suffer similar shortcomings. Many billions of these relatively expensive cups and capsules, having plastic and/or metal components, are used and disposed of each year as landfill waste, resulting in tremendous environmental stress.

Materials used in the food industry are increasingly subject to stringent environmental regulatory requirements, and consumer preferences also are evolving to favor biodegradable, compostable and recyclable products. A variety of alternative beverage cartridge configurations have been created to address the cost and environmental issues associated with K-Cup® type cartridges (whether made of plastic, aluminum, or other non-biodegradable, environmentally unfriendly materials).

Alternatives to brewing systems employing plastic cups, such as the K-Cup® type cartridges, include cup-less pods. One type of cup-less pod 9, shown in FIG. 2, functions like a standard K-Cup® and includes a plastic ring 11 covered with a foil lid 10 to seal a paper filter 12 filled with beverage material, but it does not include the K-Cup® type cartridge's plastic cup. A needle 14 pierces the foil lid 10 and injects pressurized heated water into the beverage material, and rather than brewed coffee flowing through a hole pierced through the bottom of a plastic cup, the brewed coffee flows throughout the paper filter 12 as shown by the directional arrows. This configuration is generally less expensive than a comparable K-Cup® type cartridge and it also lessens the amount of non-recyclable plastic material. However, these pods remain relatively expensive and still create significant environmental waste.

Another variant consists of a reusable plastic or metal cup and lid in which the user places a paper filter in the cup and then fills the filter with beverage material (for example, loose coffee grounds) and then places the lid on the cup. Numerous products of this sort are currently available, including the Perfect Pod® EZ-Cup® 2.0 and the Melitta® JavaJig®. This product is more environmentally friendly than K-Cup® type cartridges, because the cup and lid are reused, and only the paper filter and loose coffee grounds need to be thrown away after brewing. Cost-per-brewed cup also is generally lower than with the K-Cup® type cartridges.

However, this product requires users to carefully grind and measure the ground coffee, requiring users to purchase coffee grinding equipment, and making dosing inconsistent and delivering varying and potentially sub-par cups of coffee. It also has the disadvantages of pre-brew spillage when the coffee is ground and/or added to the filter and post-brew spillage during disposal of the paper filter and grounds. Preparation of the coffee and clean-up using this product is thus time consuming, inconvenient, inconsistent and messy.

Another variant, shown in FIG. 3, involves the use of a reusable plastic or metal filter cup 16 with built-in filtration. Numerous products of this sort are currently available, including the Keurig® My K-Cup® Universal Reusable Coffee Filter, the Ekobrew® Elite® Stainless Steel Reusable K-Cup®, as well as a variety of Nespresso® reusable filter cups. Reusable filter cups of this type are sold in both single and “carafe” sizes. In this product, loose coffee or other beverage material is poured directly into the reusable filter cup 16, and a hinged, screw-on or snap-on lid 18 is used to close the top of the filter cup body 20. Filtration is accomplished by one or more filter windows 22 (mesh or any other suitable filter mechanism) affixed to or integrated into the body 20 of the filter cup 16.

The product shown in FIG. 3, and similar products, are more environmentally friendly than K-Cup® type cartridges because the filter cup 16 and lid 18 are reusable and only the coffee grounds or other beverage material residue needs to be disposed of after brewing. Cost-per-brewed cup using this reusable filter cup product also is lower than K-Cup® type cartridges, as well as cup-less pod and reusable cup and paper filter products.

However, this product also requires users to purchase grinding equipment, and carefully measure and precisely grind the coffee, making dosing inconsistent and delivering varying and potentially sub-par cups of coffee. It also has the disadvantages of pre-brew spillage when the coffee is ground and/or added to the filter cup and post-brew spillage during disposal of the coffee grounds. Preparation of the coffee and clean-up using this product is thus time consuming, inconvenient, inconsistent and messy.

A continuing need exists for improved single-serve brewing systems and associated brewing means that are environmentally sound, cost-effective to manufacture and distribute, provide consisting dosing, and minimize user preparation and clean-up time and mess.

### BRIEF SUMMARY OF THE INVENTION

Embodiments of the present invention address and overcome the deficiencies addressed above. The inventive beverage bag described and claimed herein provides an elegant, convenient, consistent, mess-free, low-cost and environmentally-friendly alternative to the prior art brewing systems. Embodiments of the flexible and properly-dosed beverage bags of the present invention also allow for improved intermixing of pressurized heated water and the beverage material, improved extraction, and a superior flavor profile.

Embodiments of the present invention include an inventive brewing machine adapter that allows use of the inventive beverage bag described and claimed herein without the need for users to purchase a reusable cup or reusable filter cup. The adapter comprises a gasket disposed over and/or within the upper portion of the brewing machine's brewing chamber and/or on the underside of the brewing chamber cover that seals the upper portion of the brewing machine during the brewing process. The adapter also can include a plug disposed in the lower portion of the brewing chamber that, combined with the gasket, helps retain pressure in the brewing chamber during the brewing process without the need for a reusable cup or a reusable filter cup.

The foregoing presents merely a simplified, brief summary of some embodiments in order to provide a basic understanding of the invention. The present invention can be embodied many different ways. For a more complete understanding of the nature, scope and advantages of the present invention, reference also should be made to the ensuing detailed description and accompanying drawings.

### BRIEF DESCRIPTION OF THE DRAWINGS

A better understanding of the present invention may be obtained by reference to the accompanying drawings, when considered in conjunction with the other portions of the specification. The drawings illustrate only certain embodiments of this disclosure and are not to be considered to limit its scope. The disclosure supports other equally effective embodiments and it is intended to cover all such embodiments.

FIG. 1 is a side elevation view, partly in section, showing a known single-serve brewing cartridge used in a Keurig® or similar brewing system;

FIG. 2 is a side elevation view showing a known single-serve brewing pod with water injection needle piercing the lid, and representing a cup-less variation of a known single-serve brewing cartridge;

FIG. 3 is a side elevation view of a known single-serve reusable filter cup with closeable lid;

FIG. 4 is a side elevation view of a preferred embodiment of a beverage bag of the present invention;

FIG. 5 is a side elevation view of another preferred embodiment of a beverage bag of the present invention;

FIG. 6 is a perspective view of a beverage bag of the present invention, in combination with a sealing package, which contains the beverage bag prior to use;

FIG. 7 is a perspective view of a preferred beverage bag of the present invention, disposed within a reusable filter cup;

FIG. 8 is a perspective view of a known single-serve brewing machine, with a reusable filter cup and beverage bag of the present invention, with the brewing chamber in an open position;

FIG. 9 is a front elevation view of a brewing machine of a known configuration, showing a brewing chamber cover in an open position;

FIG. 10 is a side elevation view of a brewing chamber removed from the brewing machine of FIG. 9, and with a preferred configuration of the gasket of the present invention disposed on the upper rim of the brewing chamber;

FIG. 11 is a perspective view of a preferred configuration of the inventive gasket shown in FIG. 10.

FIGS. 12-13 show a perspective and side elevation view of another preferred configuration of the gasket of the present invention;

FIGS. 14-15 show perspective views of other preferred configurations of the gasket of the present invention.

FIGS. 16-17 show a perspective and side elevation view of another preferred configuration of the gasket of the present invention;

FIG. 18 is a front elevation view of a brewing machine, with the cover of the brewing chamber rotated into an upward, open position, and with a gasket according to the present invention disposed on the underside of the cover;

FIG. 19 is a top view of the brewing machine of FIG. 9, showing the bottom of the brewing chamber when installed in the brewing machine;

FIG. 20 is a top view of the brewing machine of FIG. 9, showing the bottom of the brewing chamber when installed in the brewing machine, and with an inventive plug disposed over the central drain of the brewing chamber;

FIG. 21 is a side elevation view of a preferred embodiment of the plug of the present invention;

FIGS. 22-24 show various other embodiments, in top view, of the plug of the present invention;

FIG. 25 is a top view of the brewing machine of FIG. 9, showing the bottom of the brewing chamber when installed in the brewing machine, and showing another embodiment of a plug of the present invention disposed in the brewing chamber;

FIG. 26 is a side elevation view of a brewing machine with an alternative gasket configuration; and,

FIG. 27 is a side elevation view of a preferred embodiment of the present invention in which the gasket and plug are connected.

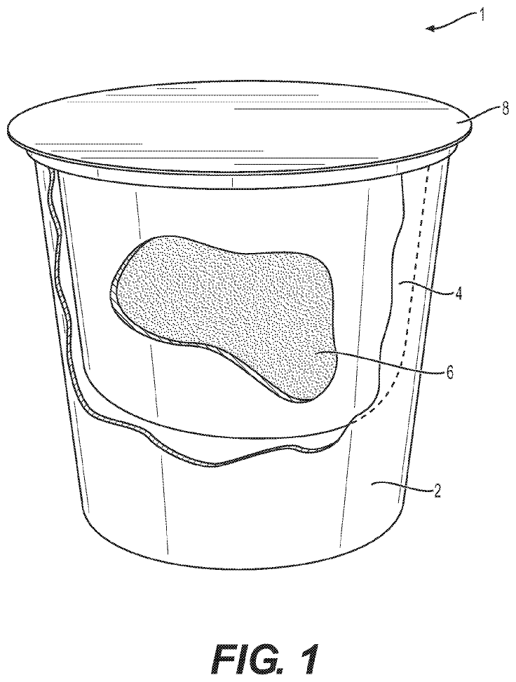

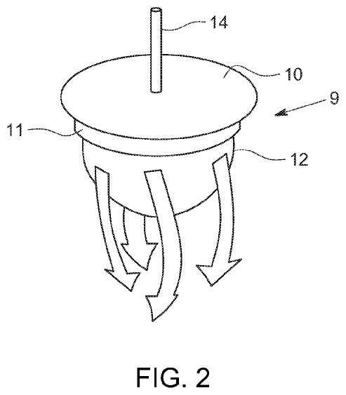

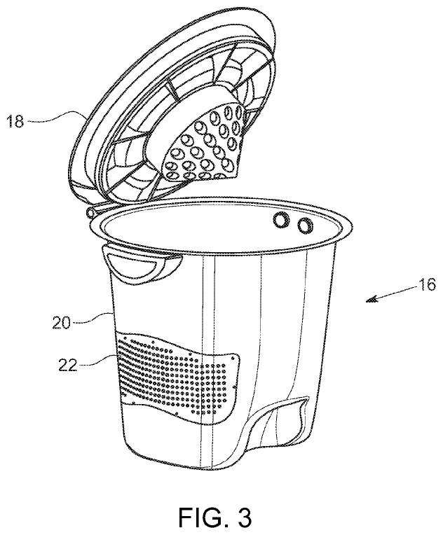

### DETAILED DESCRIPTION

The following detailed description is merely exemplary and is not intended to limit the described embodiments or the application and uses of the described embodiments. The description represents the information necessary to enable those skilled in the art to practice the invention and illustrates various methods of practicing embodiments of the invention. The general principals and information described herein may be applied to embodiments and applications other than those detailed below without departing from the spirit and scope of the disclosure and all such embodiments and applications are covered by this disclosure.

The disclosure set forth herein is to be accorded the broadest scope consistent with the principles and features disclosed or suggested herein. Upon reading the description and the other portions of the specification, including the accompanying drawings, those skilled in the art will understand the concepts of the invention and recognize applications of these concepts not particularly addressed herein, and each of these concepts and applications fall within the broad scope of the disclosure and the accompanying claims.

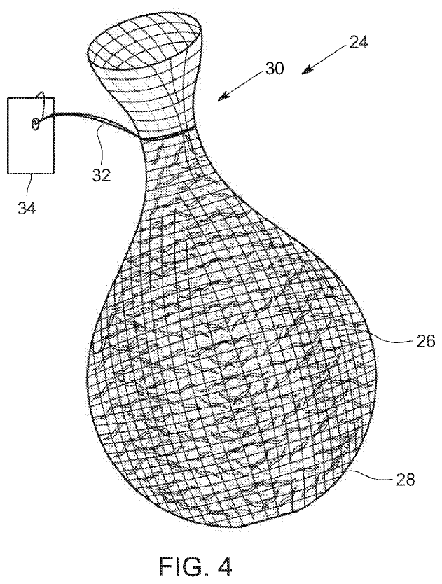

FIG. 4 illustrates a beverage bag 24 for preparing a beverage in accordance with an embodiment of the present invention. The beverage bag 24 can be free-form or any desired shape, and it can be dimensioned to fit any beverage brewing system configuration.

The beverage bag 24 is preferably made from environmentally-friendly woven or knitted materials, including material blends, that are biodegradable, compostable and/or recyclable, or any other suitable stretchy, water-permeable, eco-friendly material. The use of a woven, knitted or other stretchy water-permeable, eco-friendly material or material blend allows for improved interaction and intermixing between the pressurized heated water and the beverage material 26 and for improved extraction and flavor profile.

The water-permeability of the beverage bag 24 allows for pressurized heated water to enter the beverage bag 24 to intermix and interact with the beverage material 26 and then exit the beverage bag 24. The beverage bag 24 can be configured to capture essentially all the beverage material 26 sediment that may be generated in connection with the brewing process. The openings or holes 28 that make the beverage bag 24 water-permeable can be sized and configured based on the type and grind of the beverage material 26 contained in the beverage bag 24 to maintain optimal interaction, intermixing and extraction. The terms “opening” or “holes” can refer to mechanically formed perforations or micro-perforations in a solid, flexible sheet material, or more preferably, they refer to the natural spacing or gaps between the warp and weft strands of a woven or knitted fabric material, or the spacing between the multi-filaments that comprise individual strands of the fabric.

Because knitted fabrics generally are more stretchy (flexible and expandable) than woven fabrics, knitted fabrics are more preferred in the present invention. Moreover, “natural” fibers and fabrics such as cotton, flax, wool and hemp, and “manufactured” or “regenerated” cellulose based fibers and fabrics are preferred over nonbiodegradable synthetics, due to their natural ability to biodegrade on a relatively short time table, making them environmentally friendly.

The beverage bag 24 may contain any beverage material 26 (shown with stippled lines). Although certain of the disclosures herein reference ground coffee as the beverage material, it will be understood that all of the disclosures herein apply equally (and broadly) to other beverage material, including tea, hot chocolate and other beverage materials including cold and flu remedies, protein and health drinks, powered milk, soups, fruit and vegetable drinks, soft drinks, breakfast drinks, meal replacements and any other beverage material that can be prepared in brewing machines of the type discussed herein.

The quantity of beverage material 26 used in the beverage bag 24 is properly dosed depending on the beverage material 26 and brewing system being used, the beverage bag construction, the desired beverage flavor profile, and, if utilized, the configuration and design of the reusable cup or reusable filter cup. By example, if the beverage material is ground coffee, the quantity and grind of ground coffee can be selected to provide a mild, medium or strong brewed coffee, or any variation in between. Moreover, the fineness of the coffee grind can be selected to match with a preferred material from which the beverage bag 24 is made.

FIG. 4 illustrates one embodiment of the present invention, where the beverage bag 24 is constructed from a single, properly dimensioned piece of material that is closed using any suitable closure means 30 after the beverage material 26 is measured and placed inside the beverage bag 24. The beverage bag 24 also can be made of a fabric blend or multiple pieces of woven, knitted or other suitable fabric stitched together to form a bag-like structure which may be loaded with beverage material.

Closure means 30 that can be used to close the beverage bag 24 broadly include heat sealing, gluing, sewing; using a string, thread, cord or the like; ultrasonic fabric welding; and mechanical closures such as clips or complimentary closures such as micro-hook and micro-loop fasteners. As shown in FIG. 4, the closure means 30 may include an extended string 32, or thread, cord or the like (whether as part of the closure means or separate therefrom) which can be used to close the beverage bag 24 after filling with ground coffee or other material and/or as a means to extract the beverage bag 24 from the beverage brewing system after brewing. When using a string 32 or similar item, a tag 34 can be attached to the string 32 with the tag 34 being used to post any pertinent or desired information, including details concerning the beverage bag 24 manufacturer or seller, eco-friendliness and beverage material 26. If the beverage bag 24 is sealed with a stitched string, the string 32 can be used to supplement the seal, and/or to provide the informational tag 34.

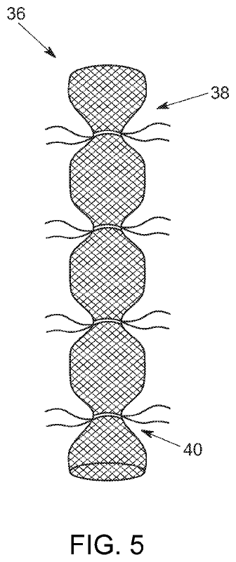

FIG. 5 illustrates another embodiment of the present invention in which the beverage bag 36 is formed from a tube of material. In this embodiment, the beverage bag 36 may comprise a continuous tube of knitted, woven or other suitable material, and individual beverage bags 36 can be formed by closing sections of the tube in which beverage material has been placed, and separating the individual beverage bags by cutting or any other suitable means, between the points or lines of closure of each beverage bag. The beverage bag 36 of this embodiment also can be made from a sheet or rectangular piece of material, preferably woven and more preferably knitted material. The beverage material, such as ground coffee, can be laid out on the piece of beverage bag 36 material, and then the beverage bag 36 material is rolled into the desired shape, e.g., a cylindrical, rounded or any other shape. The opposite ends of the beverage bag 36 material are then closed by any suitable closure means 38 and 40 with the beverage material now enclosed in the beverage bag 36.

Persons of ordinary skill in the art will recognize that other bag shapes and configurations that result in a closed beverage bag for containing beverage material are also possible and covered by this disclosure. The exact shape and size of the beverage bag may depend on various factors, including the brewing machine in which the beverage bag will be used, the type and grind of coffee or other beverage material, and/or the configuration and design of the reusable cup or reusable filter cup when one is being used. However, it is an aspect of the present invention that the beverage bag, which in the preferred embodiment takes the shape of a conventional “bag,” is flexible and somewhat amorphous in shape so that a bag of the present invention can easily be configured to fit into several different types of brewing machines and structures. The beverage bag can conform its shape to its application.

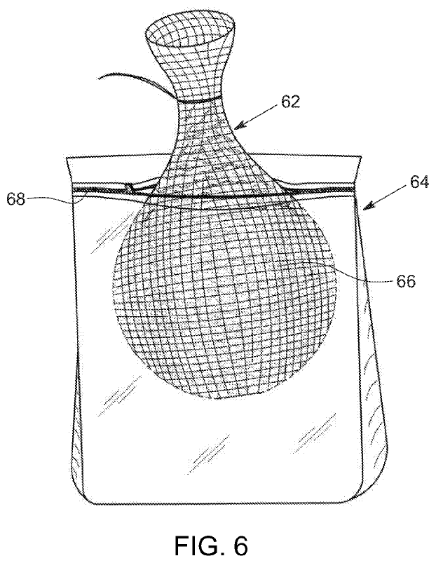

FIG. 6 illustrates an additional, optional feature of the invention in which a beverage bag 62 is positioned inside an airtight container 64 prior to use in order to keep the ground coffee or other beverage material fresh. Since the beverage bag 62 is air permeable, the airtight container 64 may be used to maintain freshness of the beverage material 66 contained therein prior to its use to prepare the beverage. The airtight container 64 may have an openable end and an opposite, closed end. When stored, and prior to use, the beverage bag 62 is enclosed completely within the airtight container 64. To remove the beverage bag 62 for use in a brewing machine, the airtight container 64 may be cut open, since the preferred material is a waterproof paper, foil, cellophane or other suitable material, which is easily cut with a knife or scissors. Alternatively, and preferably, the container 64 is provided with a score, a tab, a zip, an embedded string, or otherwise is provided with opening means 68 to assist a user in opening the airtight container 64. The airtight container 64 may be sealed at the opposite end or other sides or surfaces, by gusseting, pinching, heat sealing, stapling, or otherwise. The airtight container 64 also may be a shrink wrap container, a wax container or any other suitable airtight container. The airtight container 64 also can be configured and/or sized to hold multiple beverage bags 62.

The inventive beverage bag described and claimed herein can be used with reusable cups or reusable filter cups. As noted, a variety of such reusable cups and reusable filter cups are commercially available, and the inventive beverage bag described and claimed herein is intended for use with any cup type or configuration. When the beverage bag is used in conjunction with an all-metal reusable filter cup, there is no contact with plastic, which eliminates plastic taste and potentially harmful effects of plastic when heated and placed in contact with potable water.

The present invention preferably contemplates a combination of a reusable filter cup and beverage bag. The exact type of material, and knitting pattern, for example, are selected to allow expansion of the beverage bag during brewing (as a result of the introduction of pressurized heated water and the swelling of the coffee grinds), and to allow proper timing of exposure of the pressurized heated water to the ground coffee, thus optimizing coffee flavor extraction from the grinds and taste profile.

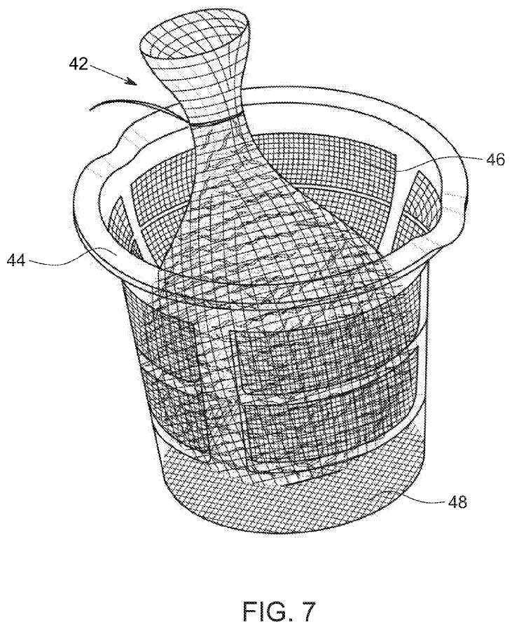

FIG. 7 illustrates an embodiment of the present invention which includes both a beverage bag 42 and a reusable filter cup 44 (shown, for ease of illustration, without a lid). The reusable filter cup 44 can have mesh sidewalls 46 alone or in combination with a mesh bottom wall 48, which, along with the other aspects of the reusable filter cup 44, including its lid, act both as a means for maintaining optimal and/or sufficient pressure in the brewing chamber of an associated brewing machine, and as an integrated filter means adapted to filter sediment from the brewed beverage while allowing the beverage to pass through the reusable filter cup 44 and brewing chamber for consumption. The extent to which the sidewalls 46 and bottom wall 48 include a mesh, are perforated or otherwise made water permeable, will depend on the desired flow rate of brewed beverage through the reusable filter cup 44 and beverage bag 42, and the brewing pressure and the desired or preferred brew profile. The beverage bag 42, due to its soft and pliable nature, can, if sized properly, adopt any suitable shape to fit in the reusable filter cup 44. Similarly, the reusable filter cup 44 can be sized and dimensioned to fit and function in any beverage brewing machine and/or system. As in the previously described embodiments, the material from which the beverage bag 42 is made is preferably a woven and more preferably a knitted, natural material (or material blend) comprising, e.g., cotton, flax, wool or hemp.

The reusable filter cup 44 may be sized and shaped to fit within the brewing chamber of existing commercially available brewing machines, such as the Keurig® machine that uses K-Cup® type cartridges which fit within the brewing chamber. With conventional K-Cup® type cartridges, an injection needle punctures the lid of a plastic cup to inject pressurized heated water into the cup itself to thereby interact with ground coffee. Brewed coffee exits the bottom of the plastic cup through a discharge needle that punctures the bottom of the plastic cup and the brewed coffee flows into a coffee cup disposed under the brewing chamber. When the brewing chamber cover is closed over the brewing chamber, a pressure chamber is formed inside the K-Cup® due to the solid sidewall, bottom and lid of the K-Cup®. When using the inventive combination of the present invention (preferably a reusable filter cup 44 with the beverage bag 42 placed therein) pressure is maintained in the brewing chamber by means of the reusable filter cup and lid (not shown) and the brewing chamber cover seating over the reusable filter cup 44. The injection and discharge needles of the machine no longer serve to puncture a solid cup, but the injection needle still functions to inject pressurized heated water into the reusable filter cup 44.

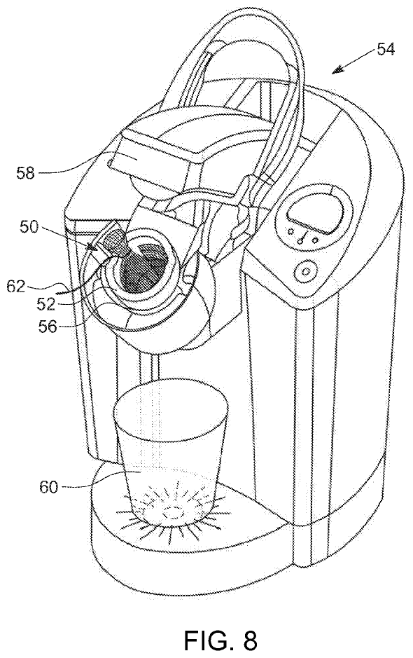

FIG. 8 illustrates a brewing system according to one embodiment of the present invention. The system includes a beverage bag 50 disposed within a reusable filter cup 52 (shown, for ease of illustration, without a lid). The system includes a brewing machine 54 which for illustration purposes can be a Keurig® beverage brewing machine 54 or any other machine with similar functions and structures. The operation of such machines is well-known and has been referred to above in part when discussing how the plastic K-Cup® type cartridges are used.

As shown in FIG. 8, the beverage bag 50 containing the beverage material, such as ground coffee, is placed inside the reusable filter cup 52 which fits inside the brewing chamber 56 of the single-serve brewing machine 54. After the machine's brewing chamber cover 58 is closed, the machine 54 is activated to cause pressurized heated water to flow into the reusable filter cup 52 and beverage bag 50, which results in the intermixing and interaction of the heated water and the beverage material, and the flow of the brewed beverage through the reusable filter cup 52 and out of the brewing chamber 56 and into a coffee cup 60 or other suitable beverage container. After the beverage preparation is completed, the machine's brewing chamber cover 58 is opened and the beverage bag 50 is removed from the brewing chamber 56, preferably by the user grasping a string 62, thread, cord or the like, and discarding the used beverage bag 50.

Tests were conducted relating to the beverage bag of the present invention using a Keurig®1.0 brewing system set at the 6 oz. brew level. The best performance in these tests was displayed using a beverage bag constructed of 32S 100% unbleached cotton knitted fabric loosely filled with about 10 grams of VT Artisan Breakfast Blend coffee (ground using a 3.5 grind setting on a Mahlkönig GmbH & Co. lab grinder) in connection with an Ekobrew® Elite® Stainless Steel Reusable filter cup. The beverage bag was sized to occupy approximately 90% of the volume of the reusable filter cup. The fabric allowed the ground coffee to expand in the brewing process optimizing extraction by allowing the pressurized heated water to come in contact with all of the ground coffee. Essentially no particles escaped, which prevented the grinds from disbursing in the filter cup and clogging the filters. The beverage bag also was easily removed from the brewing machine and the filter cup was reusable without the need for rinsing between cups.

The performance and extraction of this beverage bag configuration consistently equaled or exceeded that of ground coffee placed directly in a Keurig® My K-Cup® reusable filter cup. It also had the added benefit of being fully compostable and easily removed from the Ekobrew® filter cup and disposed of without the need for cleanup.

Additional embodiments of the present invention allow the inventive beverage bag described and claimed herein to be used with Keurig® and other brewing systems without the need for a reusable cup or reusable filter cup. In these embodiments, a gasket and plug configuration is used to seal the brewing chamber in order to maintain proper pressure during the brewing process.

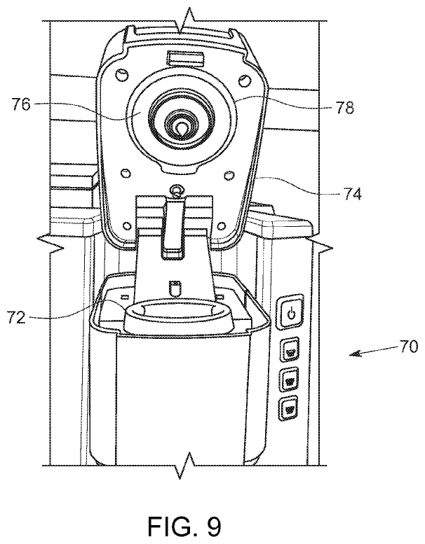

FIG. 9 shows the upper portion of the brewing machine 70 as viewed from the front. The machine includes a brewing chamber 72 which is capable of being removed for cleaning purposes. A brewing chamber cover 74, having a hinged connection above the brewing chamber 72, is shown in an open position. A water injection needle 76 is designed to inject pressurized heated water after the cover 74 is pivoted downward over the brewing chamber 72 and the brewing process is activated. The underside of the cover 74 includes an annular groove 78 which encircles the upper, annular rim of the brewing chamber 72 when the brewing chamber cover 74 is closed.

If a beverage bag of the present invention were placed directly in the brewing chamber 72 without use of a reusable cup or a reusable filter cup, the brewing chamber 72 would not act as a pressure vessel during the brewing process due to the loss of pressure at both the upper and lower portions of the brewing chamber 72. An inventive solution to this pressure loss issue which allows users to use the beverage bags of the present invention without the need for a reusable cup or a reusable filter cup is to adjoin a gasket to the upper portion of the brewing chamber 72 and/or the underside of the brewing chamber cover 74 to seal the upper portion of the brewing chamber 72 during the brewing process. The gasket(s) can be combined with a plug or plugs disposed in the lower portion of the brewing chamber 72 and configured to reduce pressure loss through the lower portion of the brewing chamber 72 during the brewing process. The gasket can be permanently adjoined to the upper portion of the brewing chamber 72 and/or the underside of the brewing chamber cover 74, or it can be adjoined so as to be removable (i.e., removably adjoined).

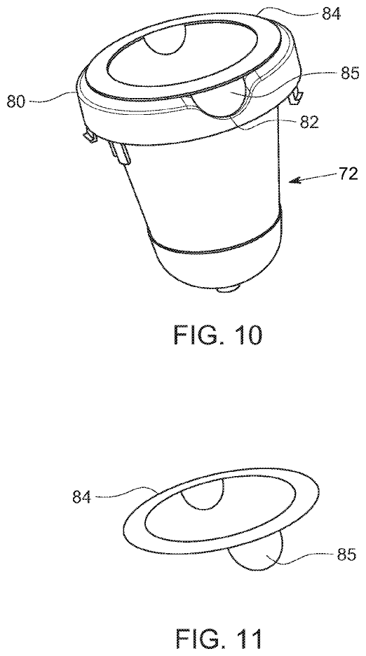

FIG. 10 illustrates the brewing chamber 72 (a plastic cup open at the top) removed from a Keurig® brewing machine. The top of the brewing chamber 72 includes an annular rim 80 with concave recesses 82 on opposite sides of the rim 80. An annular gasket 84 is shown seated on the rim 80 of the brewing chamber 72. The gasket 84 is sized to cover all or part of the width of the rim 80 of the brewing chamber 72 and it includes convex protrusions 85 configured to fit within the concave recesses 82 of the rim 80 of the brewing chamber 72. The gasket 84 is thereby configured to seal the upper portion of the brewing chamber 72 when the brewing chamber cover is closed, and it prevents pressure from escaping through the upper portion of the brewing chamber 72 during the brewing process.

FIG. 11 illustrates, in isolation, a preferred configuration of gasket 84 and the convex protrusions 85 configured to fit within the concave recesses 82 of the brewing chamber 72. This gasket 84 configuration does not require adhesive or other fastening means to remain connected to the upper portion of the brewing chamber 72, and it can easily be placed on and removed from the brewing chamber 72. The gasket 84 can be made of any suitable material (or combination of materials), including plastic, metal, rubber, cork, silicone, and it is preferably made of food grade material(s). If desired, the gasket (as with all gasket configurations of the present invention) can be attached to the upper portion of the brewing chamber 72 by any suitable means.

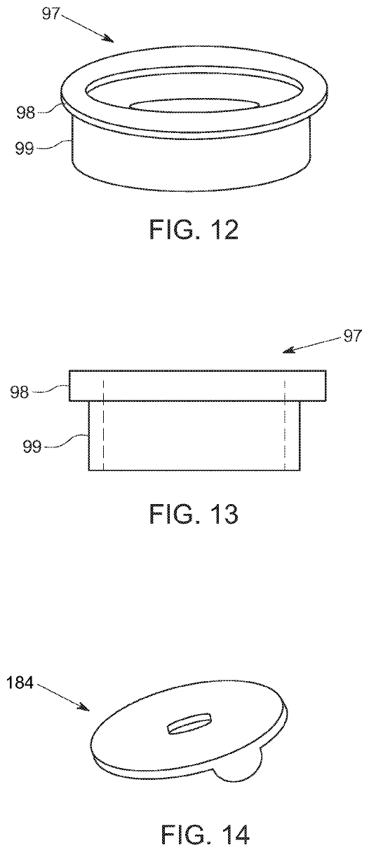

FIGS. 12-13 show a preferred “T” cross-sectional embodiment of the present invention, where the gasket 97 has a central opening, an upper annular portion 98 configured and sized to fit over all or part of the rim 80 of the brewing chamber 72, and a lower annular portion 99 configured and sized to fit snugly within the upper portion of the brewing chamber 72 and extend below the concave recesses 82 (or other non-planar portions) of the rim 80 of the brewing chamber 72. This “T” shaped gasket 97 configuration does not require adhesive or other fastening means to remain connected to the upper portion of the brewing chamber 72, and it can easily be placed on and removed from the brewing chamber 72. This preferred gasket 97 embodiment also can be made of any suitable sealing material (or combination of materials), preferably food grade material(s), and if desired, it can be attached to the upper portion of the brewing chamber 72 by any suitable means.

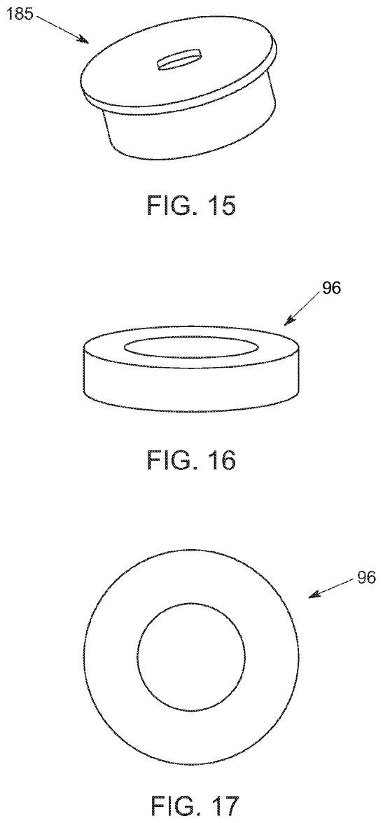

FIGS. 14-15 illustrate other preferred embodiments of the present invention, where the gaskets 184 and 185 have the cross-sectional shapes of the gaskets illustrated in FIGS. 10-13 and include a top with a central hole configured and sized to allow the brewing system injection needle to penetrate the hole when the brewing chamber cover is closed. As with the gaskets illustrated in FIGS. 10-13, the gasket in these embodiments preferably covers all or part of the rim of the brewing chamber and seals the upper portion of the brewing chamber during the brewing process. The gasket also can be configured to fit within the upper portion of the brewing chamber 72 without extending over the rim 80 of the brewing chamber 72 (e.g. configured as a disc, an inverted cup etc. that fits in and seals the upper portion of the brewing chamber 72). The gasket can be configured and sized to work with any brewing chamber 72 configuration, and it can be constructed of any suitable material (or combination of materials), including plastic, metal, rubber, cork, silicone, and preferably food grade material(s). If desired, it can be attached to the upper portion of the brewing chamber 72 by any suitable means.

The gasket of the present invention can have any cross-sectional shape that allows for sealing engagement between the gasket 84, the brewing chamber 74 and the brewing chamber cover 74. FIGS. 16-17 illustrate a rectangular cross-sectional shape, where the gasket 96 has a central opening and an annular body. The gasket also can have a U-shape or an O-shape (defining a toroidal shaped gasket), or any shape and configuration capable of sealing the upper portion of the brewing chamber 72 during the brewing process. The gasket 84 can be sized and configured to work with any brewing chamber 72 configuration. If desired and/or necessary, the gasket 84 can be attached to the upper portion of the brewing chamber 72 using any suitable means, including adhesives, complementary fasteners, interference fits, etc.

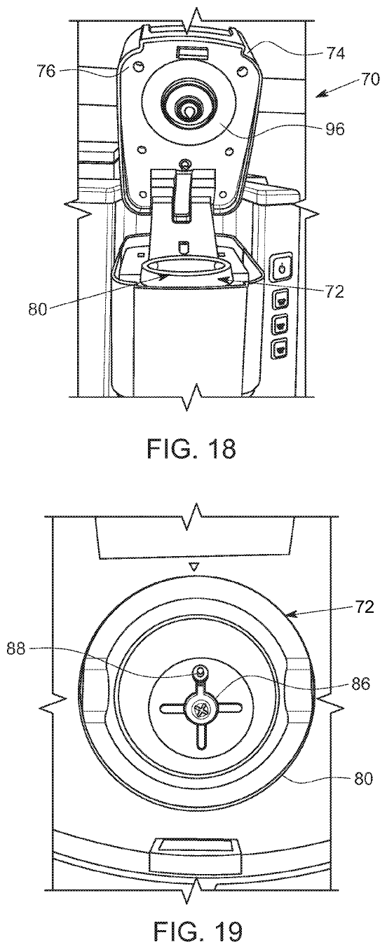

FIG. 18 illustrates an alternative embodiment, where a gasket 96 is disposed on the underside of the brewing chamber cover 74. In this embodiment, when the brewing chamber cover 74 is closed, the gasket 96 seats on the rim 80 of the brewing chamber 72, allowing, as with the previously described gasket embodiments, pressure to be maintained in the brewing chamber 72 during the brewing process and ensuring that adequate brewing conditions exist, in terms of pressure and exposure to heated water. The gasket 96 can be any appropriate cross-sectional shape and made of any suitable material (or combination of materials), including those shapes and materials described previously. The gasket 96 can be attached to the underside of the cover 74 by any suitable means, including adhesives, complementary fasteners, interference fits, etc. The gasket 96 can be used alone or in combination with any of the previously described brewing chamber 72 gasket configurations.

The gasket can be used with a plug or plugs disposed in the lower portion of the brewing chamber. The term plug is used herein in its broadest sense to mean any device that slows, blocks and/or obstructs flow through the openings in the lower portion of the brewing chamber in order to impede pressure loss in the brewing chamber during the brewing process to allow intermixing of the heated water and the beverage material. The plug can be configured based on the configuration of the brewing chamber, and it can take any shape, including, e.g., the general shape of a “stopper” type plug, a flat or shaped disc, or a cup. The plug can be configured to impede or completely obstruct pressure loss through any or all openings in the lower portion of the brewing chamber.

As illustrated by FIG. 19, the brewing chamber 72 has a drain 86 in the bottom thereof through which brewed coffee can flow into a drinking cup (not shown) positioned under the brewing chamber 72. Brewed coffee also can flow out of the brewing chamber 72 through a discharge needle 88 located in the bottom of the brewing chamber 72. The discharge needle 88 is the main exit path for brewed beverage when a K-Cup® type cartridge is used. Different brewing chamber 72 configurations also may include additional openings. The present invention uses a plug or plugs positioned in the lower portion of the brewing chamber 72 to impede pressure loss through the lower portion of the brewing chamber 72 during the brewing process.

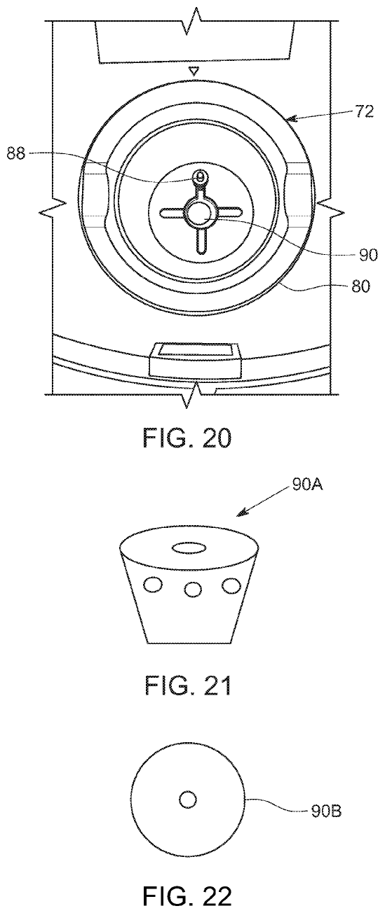

FIG. 20 illustrates one preferred embodiment of the present invention where a flow restricting plug 90 is positioned in or over the drain 86 in the bottom of the brewing chamber 72. The plug 90 can be configured in numerous ways. For example, it can be a piece of mesh material of appropriate shape and porosity to help maintain pressure within the brewing chamber 72 when pressurized heated water is injected therein. The plug 90 also can be a solid or perforated plug made of any suitable material (or combination of materials), including plastic, metal, rubber, cork, silicone, and preferably food grade material(s), with a structure capable of restricting exit flow from the brewing chamber 72 sufficient to maintain appropriate pressure during the brewing process. The plug 90 can be sized and configured to work with any brewing chamber 72 configuration.

FIG. 21 illustrates a preferred plug 90 embodiment, in which the plug 90A has a tapered annular stopper type plug shape, a central hole extending through the plug 90A from top to bottom and holes disposed around the circumference of the plug 90A that extend radially into the plug 90A and connect with the central hole. The circumferential holes preferably are positioned so that they are above the bottom of the brewing chamber 72 when the plug 90A is inserted into the drain 86. The plug 90A can include the central hole, with or without circumferential holes, or circumferential holes alone configured to drain through the bottom of plug 90A (either by being angled downward or via intersection with a central hole extending from the plug 90A bottom and intersecting with the circumferential holes). Regardless of the precise configuration, the central hole and/or circumferential holes are sized so that, in combination with the gasket 84 adjoining the upper portion of the brewing chamber 72, adequate pressure is maintained in the brewing chamber 72 during the brewing process. The plug 90A itself is sized to fit snugly within the drain 86 and it can be made of any suitable material (or combination of materials), including plastic, metal, rubber, cork, silicone, and preferably food grade material(s).

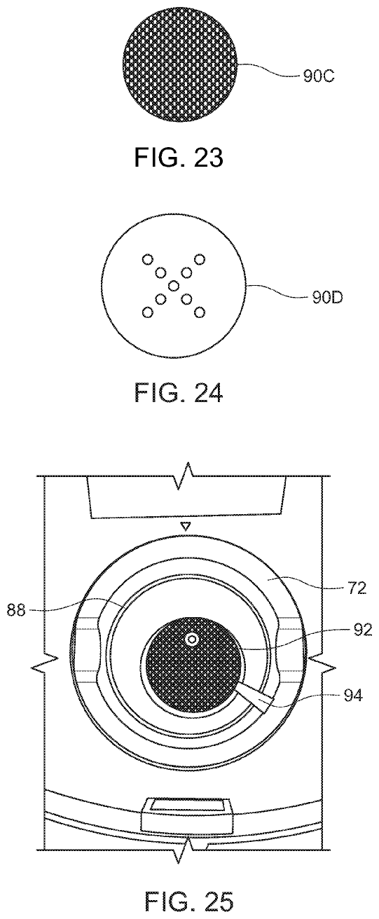

FIGS. 22-24 illustrate top views of alternative configurations of the plug 90. FIG. 22 illustrates a plug 90B with a single opening in the middle, FIG. 23 illustrates a mesh plug 90C, and FIG. 24 shows a plug 90D having a hole pattern. In each of these embodiments the hole(s) in the plug 90 are configured and sized to fit in or over the drain 86 (or other opening(s) in the lower portion of the brewing chamber 72) and, in conjunction with the gasket 84, assure that adequate pressure is maintained in the brewing chamber 72 during the brewing process.

FIG. 25 illustrates an alternative plug 92 embodiment (mesh merely for purposes of illustration) that is configured and sized to fit higher up in the lower portion of the brewing chamber 72. The discharge needle 88 extends through an opening in the plug 92. Alternatively, the plug 92 can be configured and sized so that the plug 92 (or a portion of the plug 92) is positioned above the discharge needle 88. As an added convenience, the plug can be configured to include a portion that users can hold to insert and extract the plug, or a tab 94 can be attached to the plug 92 to facilitate removal of the plug 92. Such a tab 94 also can be attached to any of the plug 92 embodiments described previously.

The various embodiments of plugs preferably work in conjunction with the previously described gasket to maintain pressure within the brewing chamber during the brewing process without the need for a reusable filter cup or a reusable cup. The plug and gasket can be configured and sized as appropriate to work with any beverage brewing system.

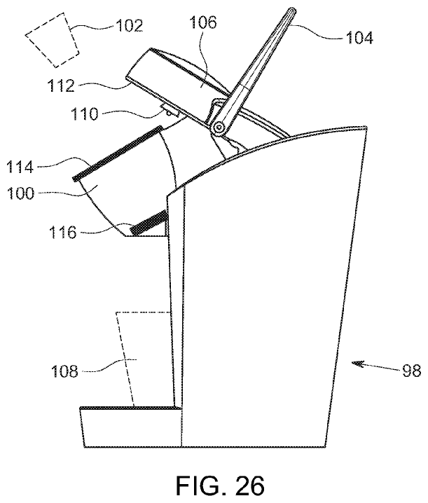

FIG. 26 illustrates an alternative gasket implementation with respect to a standard Keurig type brewing machine 98. A brewing chamber 100 is shown in the open position, just prior to the brewing operation. Normally, a K-Cup® type capsule 102 (shown in broken lines) is inserted into the brewing chamber 100, a handle 104 is operated to both close a cover 106 over the brewing chamber 100 and to move the brewing chamber 100 into a vertical position over a drinking cup 108 (shown in broken lines). In normal operation, an injection needle 110 would pierce the top lid of the K-Cup® 102 when the cover 106 and brewing chamber 100 are moved to the closed position. A discharge needle (not shown) would pierce the bottom of the K-Cup® 102, so that in a brewing operation the K-Cup® 102 itself forms a pressure vessel in which coffee is brewed.

In the illustration of FIG. 26, an upper gasket 112 can be adjoined to the inner surface of the brewing chamber cover 106, and, if desired, a lower gasket 114 can be adjoined to the upper portion of the brewing chamber 100. Also, a plug (or plugs) 116 can be disposed in the lower portion of the brewing chamber 100. Together, the upper and/or lower gaskets 112 and 114, and the plug(s) 116, create a pressure vessel within the brewing chamber such that brewing of a beverage occurs without a reusable cup or a reusable filter cup.

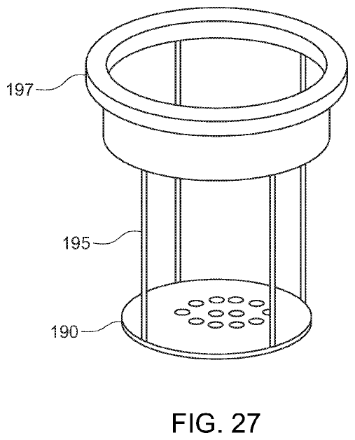

FIG. 27 illustrates another preferred embodiment of the present invention in which the gasket 197 and plug 190 are joined by a series of connectors 195. Among other things, this embodiment facilitates the insertion and removal of the plug 190 in the brewing chamber 72. The gasket 197 in this illustration is configured like the gasket 97 in FIGS. 12-13, but any of the gasket configurations discussed herein are appropriate. All that is required is that the gasket 197 seal the upper portion of the brewing chamber 72 during the brewing process. Similarly, the plug 190 in this illustration can take any of the plug configurations discussed herein. All that is required is that the plug 190 be disposed in the lower portion of the brewing chamber 72 and, in combination with the gasket 197, impede pressure loss in the brewing chamber 72 during the brewing process to assure that adequate brewing pressure is maintained. The gasket 197, plug 190 and connectors 195 can be made from any suitable material (or combination of materials), including plastic, metal, rubber, cork, silicone, and preferably food grade material(s), and they can be made from different pieces of material or from a single piece of material. The connectors 195 can be configured as one or more individual pieces joining the gasket 197 and seal 190 as illustrated in FIG. 27, or they can be configured as a single piece of material encircling the circumference of the lower portion of the gasket 197.

As but a few examples, the gasket 197 can comprise silicone or plastic, the plug 190 can comprise plastic or metal, and the connectors 195 can comprise silicone, plastic or metal. Alternatively, the gasket 197, plug 190 and connectors 195 can be formed from a single piece of plastic or silicone (with individual connectors 195 as illustrated in FIG. 27, or with a single connector 195 encircling the gasket 197 and plug 190 to form a “cup”). Alternatively, the gasket 197 can comprise silicone or plastic and the plug 190 and connector(s) 195 can be formed of separate pieces or a single piece of mesh or other appropriate material. Any configuration that maintains adequate brewing pressure in the brewing chamber 72 during the brewing process is appropriate.

As noted, the beverage bag of the present invention has many advantages over other single-serve beverage containers. The inventive beverage bag described herein is made from environmentally-friendly woven or knitted materials (or any other suitable stretchy, water-permeable, eco-friendly material) that are biodegradable, compostable and/or recyclable. Where cotton is used as the fabric, the beverage bag biodegrades in approximately 90 days in a compost or landfill. The beverage bag also offers an easy, convenient, cost-effective and mess-free way to prepare beverages, and easy, eco-friendly disposal. After brewing, essentially all of the coffee grounds remain in the beverage bag and the bag and grounds are easily disposed of in a completely eco-friendly way.

Because the beverage bags of the present invention are prefilled with beverage material, they provide the proper amount of beverage material. This compares favorably to other solutions where the user must measure out the amount of beverage material, which results in varying taste profiles as well as pre- and post-brew mess. As noted, the use of knitted or woven fabric (or other stretchy, water-permeable, eco-friendly material) in connection with the beverage bag of the present invention allows for the opening or hole size to easily be adjusted to accommodate various beverage material grinds. For example, the hole size can be designed to contain finer ground coffee than what would otherwise be filtered by the reusable filter cup alone. Also, finer grinds that would tend to clog the holes in the reusable filter cup and interfere with the working of the cup and the system can be used and contained in the inventive beverage bag. Finer ground coffee may allow for greater extraction and arguably better tasting brewed coffee.

The beverage bag of the present invention can be configured to fit within brew system cups of any size and shape. If desired, the beverage bag can be formed in a specific shape appropriate to a particular application, but the beverage bag design does not need to be structured, rigid, pre-formed or of a particular shape. Indeed, the bag is pliable and soft and can thus adopt any suitable shape to fit within a brewing machine. The beverage bag can be free-form and malleable and take the shape of the system cup, allowing for maximum dispersion of the ground coffee within the filter cup, optimal use of the space within the filter cup, and, if desired, a maximum volume of beverage material.

As a general matter, the beverage bag is not a basket, cartridge, or pod, and it is not required to have a bottom or top, sidewalls, lid, ribs, rigid screens, or a combination of materials such as plastics, mesh, non-wovens and/or metals. The beverage bag design requires little special tooling or a special manufacturing process. The beverage bag design is superior to other designs because its overall simplicity results in easier sourcing, quality control and manufacturability, as well as lower manufacturing defects and costs.

Also, the use of a knit beverage bag allows for easy sizing because knitting machines output various diameters of fabric with minor equipment adjustments. Therefore, this design of the beverage bag can easily be sized to work with any beverage brewing system, including the Keurig® and Nespresso® and other single-serve beverage machines, without the need for special tooling or new machinery. The beverage bag design of the present invention is thus readily compatible with an installed base of millions of machines and millions of reusable cups already in the marketplace.

Because openings are integral to knitted and woven fabric, the preferred use of such materials to construct the beverage bag of the present invention render the beverage bag inherently water-permeable. Construction using non-woven materials requires a mechanical process to create the openings needed for effective permeability. Knitted and woven fabrics are also inherently stretchy (flexible and expandable), allowing the beverage material to expand when the heated water enters the beverage bag, which provides better brewing and intermixing of the heated water and the beverage material. Use of non-woven material generally would not have this inherent elasticity.

Knitted and woven fabrics also allow for expansion and contraction of the openings in the fabric, which results in a “grabbing effect” on the beverage material inside the beverage bag. The openings inherent in knitted and woven fabric close when stretched in one direction which is better for removal and disposal of the grinds, or for shipping, but they open when stretched in the other direction or during expansion when water is added which allows for better for extraction and brewing. Also, the natural fibers used in connection with the beverage bag absorb water and become wetted before the grounds become wet. This pre-wetting effect is a preferred and customary aspect of preparing coffee during the pour-over coffee preparation process, often used to obtain maximum flavor from coffee.

The inventive beverage bag is designed to provide variable filtration. The beverage bag is intended to contain the beverage material during shipping and brewing, while at the same time allowing optimal operation of the reusable filter cup. The beverage bag does not adversely affect operation of the filter cup and it allows the filter cup to work as designed with the brewing system without adversely affecting pressure, heat, water flow, percolation in the filter cup or any other important aspect of beverage preparation.

An unstructured beverage bag according to the present invention is less bulky for packing and shipping purposes. As a general estimate, twenty-five of the inventive beverage bags described and claimed herein fit in the same space required for ten K-Cup® type cartridges. Unstructured beverage bags also can be shipped in any shape container, thus resulting in substantial savings in shipping costs. The inventive gasket and plug adapter described and claimed herein also can easily be shipped either with the beverage bag or separately in any shaped container, a significant benefit over the rigid and structured reusable cups and reusable filter cups.

The prefilled beverage bags of the present invention also enable a tamping effect, which compacts the ground coffee to the preferred degree for brewing. When pushing the beverage bag into the beverage brewing system cup or the reusable filter cup or the brewing chamber, the tamping effect is enhanced, without the need for a tamper, and there is no mess as the coffee remains contained within the beverage bag.

Because virtually all the beverage material remains within the beverage bag during brewing, system users can brew multiple cups of coffee before needing to clean the reusable filter cup. When cleaning is required, a simple rinse is enough. Cleaning the reusable filter cup is quick and easy as the beverage bag prevents grinds from clogging the filter cup.

The beverage bag construction avoids rupturing due to back pressure during brewing because the beverage bag prevents the grinds from clogging the holes in the reusable filter cup and the preferred knitted or woven materials used in beverage bag construction are inherently flexible and do not break during pressurized brew.

Other systems, methods, features and advantages of the present disclosure will be, or will become, apparent to one with skill in the art upon examination of the figures and detailed description contained herein. It is intended that all such additional systems, methods, features and advantages be included within this description, be within the scope of the present disclosure, and be protected by the following claims.

1-11. (canceled)

12. An adapter comprising a gasket and a plug for use with a brewing chamber of a single-serve beverage brewing machine, wherein:
(a) the gasket is configured to seal an upper portion of the brewing chamber during operation of the brewing machine; and,
(b) the plug is disposed in a lower portion of the brewing chamber and configured to impede pressure loss from the brewing chamber during operation of the brewing machine;
wherein the gasket and plug are formed of a single piece of material.

13. The adapter of claim 12, wherein the gasket is configured to removably adjoin an upper portion of the brewing chamber.

14-16. (canceled)

17. A method of brewing a beverage in a single-serve beverage brewing machine comprising:
(a) providing a gasket and a plug, each removably adjoined to a brewing chamber of the brewing machine, said gasket and plug configured to maintain pressure in the brewing chamber during the brewing process, and
(b) providing a beverage bag containing beverage material in an internal space of the brewing chamber during the brewing process;
wherein the gasket and plug are formed of a single piece of material.

18. The method of claim 17, wherein the gasket is adjoined to an upper portion of the brewing chamber.

19-20. (canceled)
